(19) United States
(12) Patent Application Publication
(10) Pub. No.: US 2006/0068244 A1
(43) Pub. Date: Mar. 30, 2006

(54) Fuel tank, fuel cell system, and hydrogen gas generator

(75) Inventors: Hideo Kitamura, Kanagawa-ken (JP); Takahiro Suzuki, Tokyo (JP); Kei Masunishi, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/234,251

(22) Filed: Sep. 26, 2005

(30) Foreign Application Priority Data
Sep. 24, 2004 (JP) 2004-278277

(51) Int. Cl. H01M 8/00

(52) U.S. Cl. 429/13

(57) ABSTRACT

A fuel tank, hydrogen gas generator, and fuel cell system having a pressure tank including a space. The pressure tank includes a portion dividing the space into spaces so that when one of the spaces is increased in volume, the other space is decreased in volume and so that the one space accommodates dimethyl ether and the other space accommodates water, an outlet for opening one of the spaces to discharge dimethyl ether, and an outlet for opening the other space to discharge water. The generator and system have a portion for using dimethyl ether and water to obtain a reformed gas containing hydrogen with carbon monoxide (CO), and a portion that removes at least a part of the CO in the reformed gas. The system has a fuel cell that uses hydrogen in the reformed gas and oxygen in the atmosphere to generate electric power.

### CROSS-REFERENCE TO RELATED APPLICATIONS

This application is based upon and claims the benefit of priority from the prior Japanese Patent Application No. 2004-278277, filed Sep. 24, 2004, the entire contents of which are incorporated herein by reference.

### BACKGROUND OF THE INVENTION

1. Field of the Invention

The present invention relates to fuel cell systems that generate electric power making use of hydrogen, fuel tanks used in hydrogen manufacturing apparatuses, and hydrogen gas generators.

2. Description of the Related Art

In recent years, fuel cell systems have been highly anticipated as an electric source for portable electronic equipment, which support an information oriented society, and thus various types of fuel cells have been developed.

Fuel cell systems that make use of saturated vapor pressure of dimethyl ether to feed fuel have been considered for several reasons. Saturated vapor pressure of dimethyl ether at normal temperature is as high as about six times greater than atmospheric pressure. Also, dimethyl ether can be reformed at low temperatures as compared with natural gas or the like. Further, since dimethyl ether does not contain sulfur content, it can be readily liquefied. Accordingly, a fuel cell system that makes use of saturated vapor pressure of dimethyl ether to feed a fuel dispenses with any pump for feeding of the fuel to a fuel cell, so such systems have been given special attention.

Dimethylether and water are mixed before hand with each other at a ratio suited to generation of electric power, and the mixed liquid (fuel) is accommodated in a conventional fuel tank for fuel cells A valve connected to the fuel tank is opened and closed to control pressure on a fuel cell system, and thus the supply of fuel (Japanese Patent Application No 2004-127625).

With such fuel cell systems, however, vapor pressure of dimethyl ether typically acts on the side of the valve connected to a fuel tank and pressure suddenly drops in the valve, so that liquefied dimethyl ether vaporizes when the valve is opened.

Beyond the valve, a fuel in a state of gas-liquid two-phase flow composed of liquid water and gaseous dimethyl ether is fed to the fuel cell system.

The fuel in a state of gas-liquid two-phase flow causes a problem in that it becomes turbulent in flow as the fuel flows between an interior of the valve and an interior of the fuel cell system, thus providing a varied rate of flow and composition.

Also, a mixed liquid of dimethyl ether and water is strongly corrosive and aggressive against a fuel tank, in particular, resins and rubber. Accordingly, such fuel tanks have a short service life and there is a possibility of fuel leaks due to the formation of cracks in the fuel tank.

### SUMMARY OF THE INVENTION

The present invention has been developed in view of the above problems. The invention advantageously provides a fuel tank, a fuel cell system, and a hydrogen gas generator, in which a fuel is less varied in rate of flow and composition and which are extended in service life.

Thus, according to one aspect of the present invention, there is provided a fuel tank including a pressure tank including a space configured to accommodate dimethyl ether and water, a dividing portion dividing the space into spaces so that when one of the spaces is increased in volume, the other of the spaces is decreased in volume and so that the one of the spaces is configured to accommodate dimethyl ether and the other of the spaces is configured to accommodate water, a first outlet provided on the pressure tank so that the one of the spaces can be opened and dimethyl ether taken out therethrough, and a second outlet provided on the pressure tank so that the other of the spaces can be opened and water taken out therethrough.

According to another aspect of the invention, there is provided a hydrogen gas generator including a pressure tank including a space configured to accommodate dimethyl ether and water, a dividing portion dividing the space into spaces so that when one of the spaces is increased in volume, the other of the spaces is decreased in volume and so that the one of the spaces is configured to accommodate dimethyl ether and the other of the spaces is configured to accommodate water, a first outlet provided on the pressure tank so that the one of the spaces can be opened and dimethyl ether taken out therethrough, a second outlet provided on the pressure tank so that the other of the spaces can be opened and water taken out therethrough, a reforming portion configured to use dimethyl ether and water to obtain a reformed gas containing hydrogen with carbon monoxide (CO), and a CO removing portion that is configured to remove at least a part of the CO contained in the reformed gas.

Furthermore, according to another aspect of the invention, there is provided a fuel cell system including a pressure tank including a space configured to accommodate dimethyl ether and water, a dividing portion dividing the space into spaces so that when one of the spaces is increased in volume, the other of the spaces is decreased in volume and so that the one of the spaces is configured to accommodate dimethyl ether and the other of the spaces is configured to accommodate water, a first outlet provided on the pressure tank so that the one of the spaces can be opened and dimethyl ether taken out therethrough, a second outlet provided on the pressure tank so that the other of the spaces can be opened and water taken out therethrough, a reforming portion configured to use dimethyl ether and water to obtain a reformed gas containing hydrogen with carbon monoxide (CO), a CO removing portion that is configured to remove at least a part of the CO contained in the reformed gas, and a fuel cell that is configured to use hydrogen contained in the reformed gas and oxygen in the atmosphere to generate electric power.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a view showing a fuel cell system, in which a first embodiment of a fuel tank for fuel cells, according to the present invention, is used;

FIG. 2 is a view showing the construction of the first embodiment of the fuel tank for fuel cells;

FIG. 3 is a view showing the construction of a modified version of the first embodiment of the fuel tank for fuel cells, according to the invention;

FIG. 4 is a view showing a modification of a valve used in the first embodiment of the fuel tank for fuel cells;

FIG. 5 is a view showing the construction of a second embodiment of a fuel tank for fuel cells, according to the present invention;

FIG. 6 is a view showing the construction of the second embodiment of the fuel tank for fuel cells;

FIG. 7(a) is a view showing float of a modified version of the second embodiment of the fuel tank for fuel cells, according to the invention;

FIG. 7(b) is a view showing the float of FIG. 7(a) in an inclined position on the left side of the figure and in an upright position on the right side of the figure; and

FIG. 8 is a view showing a hydrogen gas generator, in which a tank for a hydrogen gas generator according to the invention is used.

### DETAILED DESCRIPTION OF THE INVENTION

Embodiments of the invention will be described below with reference to the drawings in which like reference numerals designate identical or corresponding parts throughout the several views. In addition, while a fuel tank for fuel cells, according to the invention, is taken as an example and described herein, the invention is not limited thereto but applicable to other fuel tanks such as fuel tanks for hydrogen gas generators, etc.

### First Embodiment

FIG. 1 shows a fuel cell system, in which a first embodiment of a fuel tank for fuel cells, according to the invention, is used.

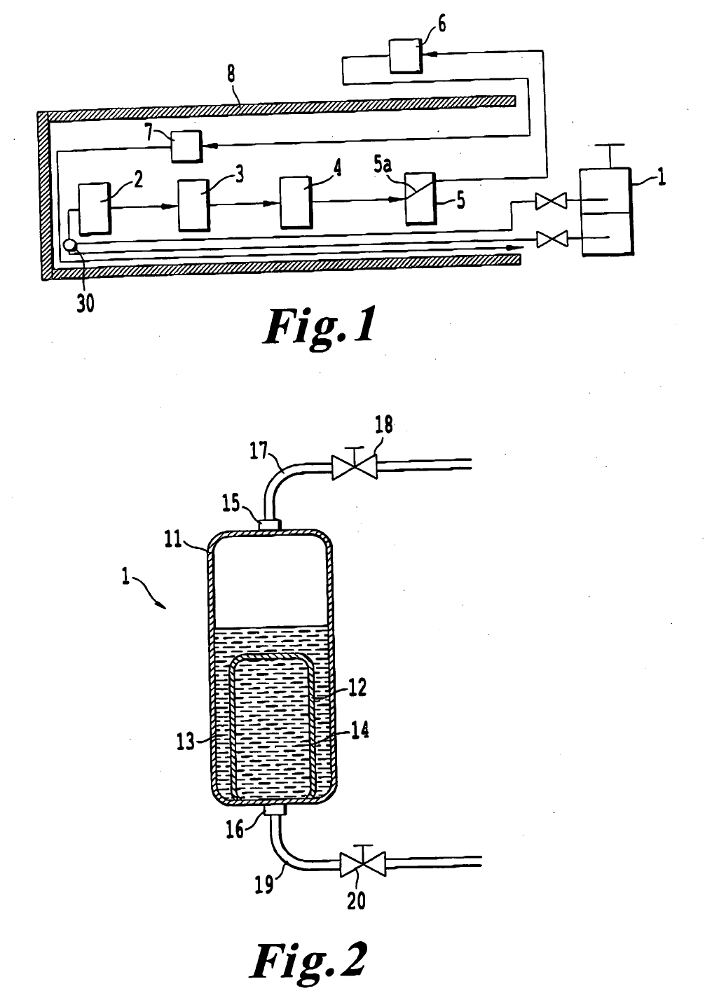

A fuel tank 1 for fuel cells accommodates therein dimethyl ether 13 (see, e.g., FIG. 2) being a fuel for the fuel cell system, and water 14. The fuel tank 1 for fuel cells can use a pressure tank, for example, a cartridge that can be mounted to and dismounted from the fuel cell system. A fuel can be fed to a vaporization portion 2 by using pressure of the dimethyl ether 13, which will be described later in detail.

A ratio (mole ratio) of dimethyl ether 13 and water 14 is ideally 1:3 stoichiometrically. In actual fuel cell systems, however, when a ratio of dimethyl ether 13 and water 14 is nearly 1:3, carbon monoxide is increased in formation. Further, since surplus water 14 can be used for a shift reaction (described later) and generation of electrical power, it is preferable that the mole ratio be larger than 1:3 by increasing the amount of water as compared to the amount of dimethyl ether. When water 14 is increased in quantity, however, energy will be increased when a fuel is heated and vaporized in the vaporization portion 2 described later. Therefore, a ratio of dimethyl ether 13 and water 14 is preferably at most 1:5.0, ideally at most 1:4.0 (for example, 1:3.5).

The vaporization portion 2 is connected to the fuel tank 1, through piping or the like. Water contained in the fuel fed to the vaporization portion 2 is heated and vaporized.

A reforming portion 3 is connected to the vaporization portion 2 through piping or the like. The fuel vaporized and fed to the reforming portion 3 is reformed in the reforming portion 3 to make a gas (reformed gas) containing hydrogen. Provided in the reforming portion 3 is a channel, through which the vaporized gas passes. A reforming catalyst is supported on an inner wall surface of the channel. The reforming catalyst is provided for accelerating the reforming of the vaporized gas to the reformed gas.

A carbon monoxide (CO) shift portion 4 is connected to the reforming portion 3 through piping or the like. The reformed gas having been reformed in the reforming portion 3 and fed to the CO shift portion 4 contains carbon dioxide and carbon monoxide as by-products in addition to hydrogen. Carbon monoxide deteriorates an anode catalyst of a fuel cell to cause degradation in performance of power generation of the fuel cell system. Therefore, the CO shift portion 4 causes the shift reaction of carbon monoxide into carbon dioxide and hydrogen before a gas containing hydrogen is supplied to a fuel cell 6 from the reforming portion 3. As a result, hydrogen is increased in formation. Provided in the CO shift portion 4 is a channel, through which the reformed fuel passes. A CO shift catalyst is supported on an inner wall surface of the channel. The shift catalyst is provided for accelerating the water-gas shift reaction of carbon monoxide contained in the reformed gas.

A CO removing portion 5 is connected to the CO shift portion 4 through piping or the like. The reformed gas having undergone the shift reaction in the CO shift portion 4 and having been fed to the CO removing portion 5 still contains carbon monoxide of 1% to around 2%. Carbon monoxide causes degradation in performance of power generation of the fuel cell system as described above. Therefore, the CO removing portion 5 causes the methanation reaction of carbon monoxide into methane and water to remove carbon monoxide, before a gas containing hydrogen is supplied to the fuel cell 6 from the reforming portion 3. Provided in the CO removing portion 5 is a channel, through which the reformed fuel passes. A CO selective methanation catalyst is supported on an inner wall surface of the channel. The CO selective methanation catalyst is provided for accelerating the methanation reaction of carbon monoxide contained in the reformed gas.

The fuel cell stack 6 is connected to the CO removing portion 5 through piping or the like. The reformed gas, from which carbon monoxide is removed, is fed to the fuel cell stack 6. The fuel cell stack 6 causes hydrogen in the reformed gas and oxygen in the atmosphere to react with each other. As the reaction proceeds, the fuel cell stack 6 forms water and generates electric power.

A combusting portion 7 is connected to the fuel cell stack 6 through piping or the like. In the fuel cell stack 6, hydrogen and oxygen reacts with each other to form water. Also, a gas discharged from the fuel cell stack 6 contains unreacted hydrogen.

The combusting portion 7 causes combustion of the unreacted hydrogen with the use of oxygen in the atmosphere. At this time, heat of combustion generated at the time of combustion is used to heat the vaporization portion 2, the reforming portion 3, the CO shift portion 4, and the CO removing portion 8. A heat insulating portion 8 covers peripheries of the vaporization portion 2, the reforming portion 3, the CO shift portion 4, the CO removing portion 5, and the combusting portion 7. The heat insulating portion 8 contributes to an improvement in heating efficiency, maintenance of uniform temperature, and protection of parts, such as electronic circuits, etc., having a low heat resistance.

FIG. 2 shows details of the fuel tank 1 for fuel cells. Provided in a pressure tank 11 is a space that accommodates dimethyl ether 13 and water 14 therein. The pressure tank 11 can be formed from, for example, a fluoro resin.

A dividing portion 12 is provided in the pressure tank 11. The dividing portion 12 divides the space in the pressure tank 11 into at least two spaces. The dividing portion 12 is provided such that when one of the spaces is increased in volume, the other of the spaces is decreased in volume. Specifically, the dividing portion 12 can comprise a sheet-shaped member, which is formed into, for example, a bag, as shown in FIG. 2. In particular, the dividing portion 12 is preferably made of a flexible member because the dividing portion 12 can be easily deformed according to changes in one of the spaces and the other of the spaces.

Dimethyl ether 13 as liquefied is accommodated in one of the spaces. Saturated vapor pressure of dimethyl ether 13 acts on the pressure tank 11, so that dimethyl ether 13 is accommodated in a state in which a part thereof is liquid and the other part thereof is gaseous. Saturated vapor pressure of dimethyl ether 13 is about six times atmospheric pressure at, for example, normal temperature. That is, pressure in the pressure tank 11 at normal temperature is about six times atmospheric pressure in a state in which the pressure tank 11 is closed.

Water 14 is accommodated in the other of the spaces. Pressure in the pressure tank 11 due to saturated vapor pressure of dimethyl ether 13 also acts on water 14.

The pressure tank 11 is provided with a dimethyl-ether outlet 15 so that one of the spaces can be opened. The dimethyl-ether outlet 15 is provided so that gaseous dimethyl ether 13 can be taken out when the fuel tank 1 is used for generation of electrical power. For example, the dimethyl-ether outlet 15 can use a self-seal mechanism built-in type pipe joint provided in a position corresponding to an upper end of the pressure tank 11 when the fuel tank 1 is used for generation of electrical power. For example, chloroprene rubber can be used for a sealing member of the self-seal mechanism.

The pressure tank 11 is provided with a water outlet 16 so that the other of the spaces can be opened. The water outlet 16 is provided so that liquid water 14 can be taken out when the fuel tank 1 is used for generation of electrical power. For example, the water outlet 16 can use a self-seal mechanism built-in type pipe joint provided in a position corresponding to a lower end of the pressure tank 11 when the fuel tank 1 is used for generation of electrical power. For example, chloroprene rubber can be used for a sealing member of the self-seal mechanism.

The dimethyl-ether outlet 15 is provided so as to be connectable to the vaporization portion 2 with the use of a dimethyl-ether pipe 17. The dimethyl-ether pipe 17 is provided with a valve 18. The valve 18 is provided so as to be able to adjust a flow rate of dimethyl ether 13 supplied to the vaporization portion 2 from the fuel tank 1.

Likewise, the water outlet 16 is provided so as to be connectable to the vaporization portion 2 with the use of a water pipe 19. The water pipe 19 is provided with a valve 20. The valve 20 is provided so as to be able to adjust a flow rate of water 14 supplied to the vaporization portion 2 from the fuel tank 1.

Dimethyl ether 13 having passed through the valve 18 and water 14 having passed through the valve 20 are mixed together at a mixing portion 30 before being supplied to the vaporization portion 2. As described above, dimethyl ether 13 and water 14 thus mixed together are supplied to the vaporization portion 2, and water 14 is vaporized.

The fuel cell system controls opening degrees of the valve 18 and the valve 20 to thereby enable controlling electric power generation. Also, in the case where pressure of either of dimethyl ether 13 and water 14, which are supplied to the vaporization portion 2, does not reach saturated vapor pressure of dimethyl ether 13 even in a state in which the valve 18 and the valve 20 are opened at maximum opening degree, emptiness of fuel can be detected assuming that dimethyl ether 13 or water 14, which is accommodated in the fuel tank 1, is considerably decreased in residual quantity.

In addition, the case where saturated vapor pressure of dimethyl ether 13 is not reached includes the case where a threshold value of saturated vapor pressure, which is corrected taking into account a pressure loss in a path leading to the vaporization portion 2 from the fuel tank 1 and errors of sensors, etc., that detect pressures or the like of dimethyl ether 13 and water 14, is not reached.

With the fuel tank 1 constructed in this manner, gaseous dimethyl ether 13 and liquid water 14 are supplied in separate states between interiors of the valve 18 and the valve 20 and the mixing portion 30, in which dimethyl ether 13 and water 14 are mixed with each other. Accordingly, a gas-liquid two-phase fuel does not pass through the valve 18 and the valve 20, so that turbulence in flow of dimethyl ether 13 and water 14 is suppressed. Accordingly, it is possible to suppress a phenomenon in which dimethyl ether 13 and water 14 are varied in rate of flow and composition.

Also, the fuel tank 1 is not exposed to a mixed liquid of dimethyl ether 13 and water 14, which is highly corrosive. Accordingly, the fuel tank 1 can have an extended service life.

Also, since when one of the spaces is increased in volume, the other of the spaces is decreased in volume, the pressure tank 11 does not need any pressurizing device, such as piping or the like, by which saturated vapor pressure of dimethyl ether 13 accommodated in one of the spaces is applied to water 14 accommodated in the other of the spaces. Accordingly, dimethyl ether 13 and water 14, which can be accommodated in the fuel tank 1, can be increased in volume, so that it is possible to continue operation of the fuel cell system over a further long term.

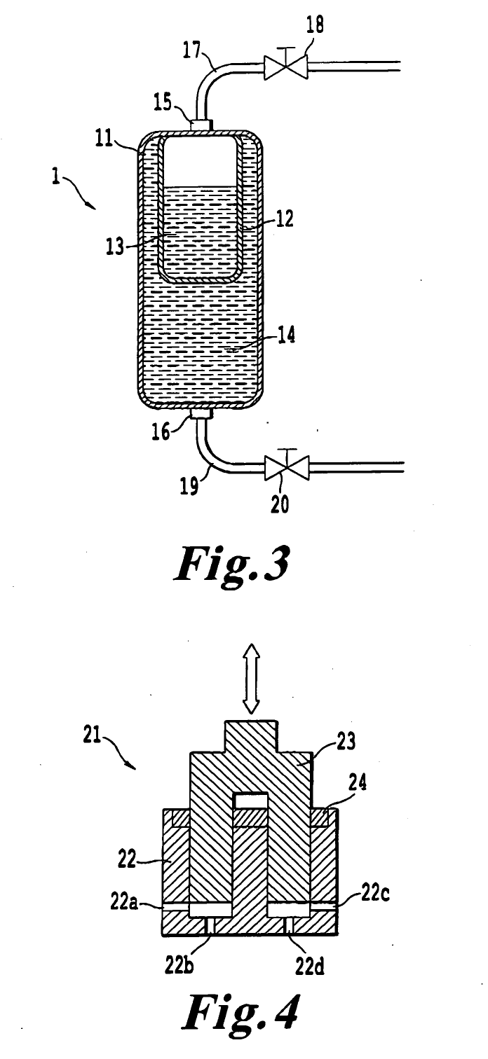

In addition, with the fuel tank 1 shown in FIG. 2, an opening of the dividing portion 12 is provided in the neighborhood of the water outlet 16 of the pressure tank 11. As shown in FIG. 3, however, such opening of the dividing portion 12 can alternatively be provided in the neighborhood of the dimethyl-ether outlet 15 of the pressure tank 11.

Also, the fuel tank 1 shown in FIG. 2 has been described with respect to the embodiment in which two valves composed of the valve 18 and the valve 20 are controlled in opening degree in order to control electric power generation of the fuel cell system. As shown in FIG. 4, however, electric power generation of the fuel cell system can also be controlled with only a single valve 21.

A valve housing 22 is provided with ports 22a to 22d. The valve housing 22 is provided with a plunger 23 that switches between a state of communication and a state of closure between the port 22a and the port 22b, and between the port 22c and the port 22d. The plunger 23 is provided so that reciprocation of the plunger 23 enables switching. A packing 24 can be provided on a part of a slide portion between the valve housing 22 and the plunger 23. The packing 24 is provided in order to prevent leakage of dimethyl ether 13 and water 14, which flow in the valve 21.

Mere reciprocation of a single plunger enables the valve 21 to control fluids of two systems in flow rate. With a fuel cell system making use of the fuel tank 1 according to this embodiment, a single actuator can control dimethyl ether 13 and water 14 in flow rate when the fuel cell system is used so that, for example, dimethyl ether 13 flows from the port 22a to the port 22b and water 14 flows from the port 22c to the port 22d. That is, since the number of actuators can be reduced, the fuel cell system can be made further small in size.

### Second Embodiment

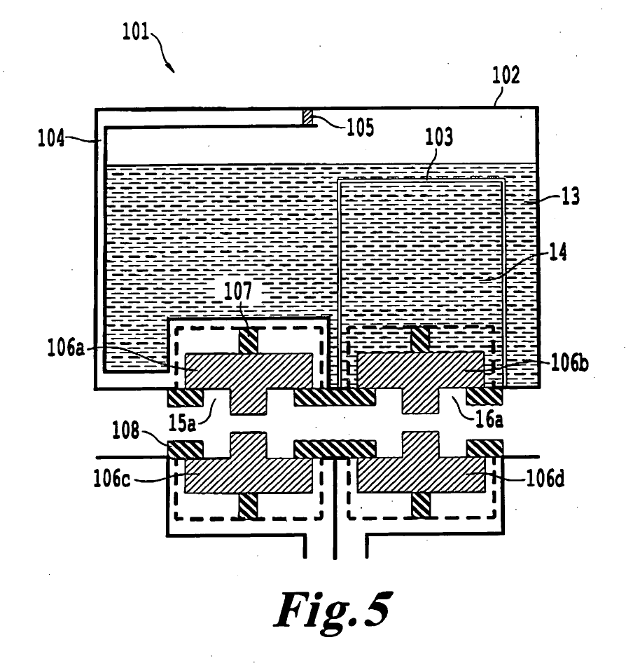

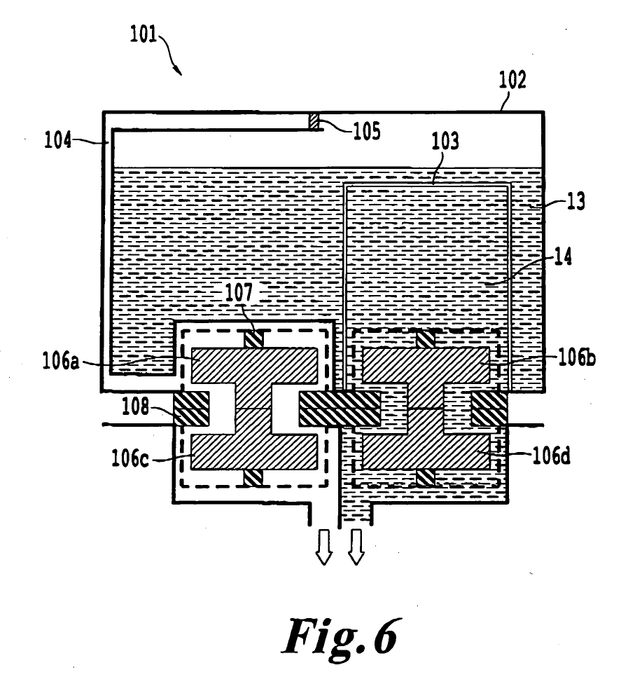

FIGS. 5 and 6 show a second embodiment of a fuel tank for fuel cells, according to the invention. In addition, the same parts as those of the first embodiment shown in FIG. 1 are denoted by the same reference numerals as those of the latter, and an explanation therefor is omitted.

The fuel tank 101 for fuel cells is provided to be able to be mounted to and dismounted from the fuel cell system. FIG. 5 is a view showing the fuel tank 101 in a state of being disconnected from the fuel cell system. FIG. 6 is a view showing the fuel tank 101 in a state of being connected to the fuel cell system.

Provided in a pressure tank 102 is a space that accommodates therein dimethyl ether 13 and water 14. The pressure tank 102 can be formed from, for example, a fluoro resin.

A dividing portion 103 is provided in the pressure tank 102. The dividing portion 103 divides the space in the pressure tank 102 into at least two spaces. The dividing portion 103 is provided such that when one of the spaces is increased in volume, the other of the spaces is decreased in volume. Specifically, the dividing portion 103 can comprise a sheet-shaped member that is formed into a bag, for example, preferably a sheet-shaped member made of a flexible member in the same manner as in the first embodiment.

Dimethyl ether 13 as liquefied is accommodated in one of the spaces. Saturated vapor pressure of dimethyl ether 13 acts on the pressure tank 102, so that dimethyl ether 13 is accommodated in a state in which a part thereof is liquid and the other part thereof is gaseous. Saturated vapor pressure of dimethyl ether 13 is about six times atmospheric pressure at, for example, normal temperature. That is, pressure in the pressure tank 102 at normal temperature is about six times atmospheric pressure in a state in which the pressure tank 102 is closed.

Water 14 is accommodated in the other of the spaces. Pressure in the pressure tank 102 due to saturated vapor pressure of dimethyl ether 13 also acts on water 14.

The fuel tank 101 can be provided to be able to be mounted to and dismounted from the fuel cell system. The pressure tank 102 is provided with a dimethyl-ether supply flow passage 104 so that gaseous dimethyl ether 13 can be supplied through a dimethyl-ether outlet 15a to the fuel cell system from one of the spaces in the fuel tank 101 for fuel cells. Specifically, one end of the dimethyl-ether supply flow passage 104 is opened in a direction in which the fuel cell system is disposed upward in operation. The other end of the dimethyl-ether supply flow passage 104 is opened outside the pressure tank 102 so that the dimethyl-ether outlet 15a constitutes an opening. Also, a gas-liquid separation membrane 105 can be provided in the neighborhood of one end of the dimethyl-ether supply flow passage 104. The gas-liquid separation membrane 105 is provided in order to prevent liquid dimethyl ether 13 from being mixed in the fuel cell system.

The pressure tank 102 is provided with a water outlet 16a so that liquid water 14 can be supplied to the fuel cell system from the other of the spaces in the fuel tank 101 for fuel cells. The water outlet 16a is provided on the pressure tank 102 so as to enable opening the other of the spaces in the fuel tank 101.

Valve members 106a to 106d are provided in the fuel cell system and the pressure tank 102 so that dimethyl ether 13 and water 14 can be supplied from one of the spaces and the other of the spaces. The valve member 106a is provided in order to stop the supply of dimethyl ether 13 by means of closure of the dimethyl-ether outlet 15a when the fuel tank 101 is put in a state of being separated from the fuel cell system. The valve member 106b is provided in order to stop the supply of water 14 by means of closure of the water outlet 16a when the fuel tank 101 is put in a state of being separated from the fuel cell system. The valve members 106c, 106d are provided in order to prevent leakage of dimethyl ether 13 and water 14 which remain in the fuel cell system, when the fuel tank 101 for fuel cells is put in a state of being separated from the fuel cell system.

The valve members 106a to 106d are provided with elastic bodies 107 in order to prevent leakage of dimethyl ether 13 and water 14 from the fuel tank 101 when the fuel tank 101 for fuel cells is put in a state of being separated from the fuel cell system. Elastic forces of the elastic bodies 107 push the valve members 106a to 106d in a direction of closure. For example, elastomer, leaf springs, coil springs, etc. can be used for the elastic bodies 107.

The pressure tank 102 is provided with a seal 108 in order to prevent leakage of dimethyl ether 13 and water 14 from a boundary portion of the fuel tank 101 and the fuel cell system when the fuel tank 101 is connected to the fuel cell system. Also, a seal 108 is also provided in the fuel cell system. For example, rubber, such as chloroprene rubber, etc., having a low elasticity can be used for the seal 108.

In the case where the fuel tank 101 is connected to the fuel cell system, the seal 108 provided in the fuel tank 101 comes into contact with the seal 108 provided in the fuel cell system. Therefore, leakage of dimethyl ether 13 and water 14 is prevented. Also, contact is caused between the valve member 106a and valve member 106c and between valve member 106b and valve member 106d, and a pushing force is provided therebetween. Thereby, the elastic bodies 107 contract, so that the valve members 106a to 106d are moved in a direction of opening. Then, dimethyl ether 13 and water 14 can be supplied to the fuel cell system from the fuel tank 101 for fuel cells.

Like the first embodiment, dimethyl ether 13 and water 14 having been supplied to the fuel cell system are supplied to the vaporization portion 2 by way of a dimethyl-ether pipe and a water pipe, which are not shown. Also, valves (not shown) are used to enable adjusting flow rates of dimethyl ether 13 and water 14 as supplied, thus enabling adjusting electric power generation of the fuel cell system.

With the fuel tank 101 constructed in this manner, gaseous dimethyl ether 13 and liquid water 14 are supplied separately between interiors of the valves and the mixing portion 30, in which dimethyl ether 13 and water 14 are mixed with each other, in the same manner as in the first embodiment. Accordingly, a gas-liquid two-phase fuel does not pass through the valves, so that turbulence in flow of dimethyl ether 13 and water 14 is suppressed. Accordingly, it is possible to suppress a phenomenon in which dimethyl ether 13 and water 14 are varied in rate of flow and composition.

Also, the fuel tank 101 is not exposed to a mixed liquid of dimethyl ether 13 and water 14, which is highly corrosive, in the same manner as in the first embodiment. Accordingly, the fuel tank 101 can have an extended service life.

Also, like the first embodiment, the pressure tank 102 is provided with the dividing portion 103 such that when one of the spaces is increased in volume, the other of the spaces is decreased in volume. Therefore, there is no need for any piping or the like, by which saturated vapor pressure of dimethyl ether 13 accommodated in one of the spaces is applied to water 14 accommodated in the other of the spaces. Accordingly, dimethyl ether 13 and water 14, which can be accommodated in the fuel tank 101, can be increased in volume, so that it is possible to continue operation of the fuel cell system over a further long term.

Also, the fuel tank 101 can be mounted to and dismounted from the fuel cell system, and without manipulation by a user, switching is made between a state in which dimethyl ether 13 and water 14 can be supplied when the fuel tank 101 and the fuel cell system are put in a state of being connected together, and a state, in which leakage of dimethyl ether 13 and water 14 is prevented when the fuel tank 101 and the fuel cell system are put in a state of being separated from each other. Accordingly, when the fuel cell system is to be replenished with a further fuel, a user can safely and surely supply a fuel by merely exchanging the fuel tank 101.

Further, when a user exchanges the fuel tank 101, the work of exchange of the fuel tank 101 can be made easy by making directions, in which the dimethyl-ether outlet 15a and the water outlet 16a are mounted and dismounted substantially in parallel to each other. For example, a locking method of bringing about a locked state upon a push operation and bringing about a lock released state upon another push operation is used to enable mounting and dismounting the fuel tank 101 from the fuel cell system by way of simple push operations. Here, the term substantially in parallel to means a situation in which a difference in parallelism to such an extent that there is no interference with mounting and dismounting of the fuel tank 101, for example, a work tolerance to such an extent that there is no interference with mounting and dismounting of the fuel tank 101.

In addition, the embodiment has been described with respect to the case where the fuel cell system is not operated in a state of being turned upside down. With that fuel cell system, of which operation continues also in a state of being turned upside down, supply of gaseous dimethyl ether 13 must be continued in a state in which the fuel tank 101 for fuel cells is also turned upside down.

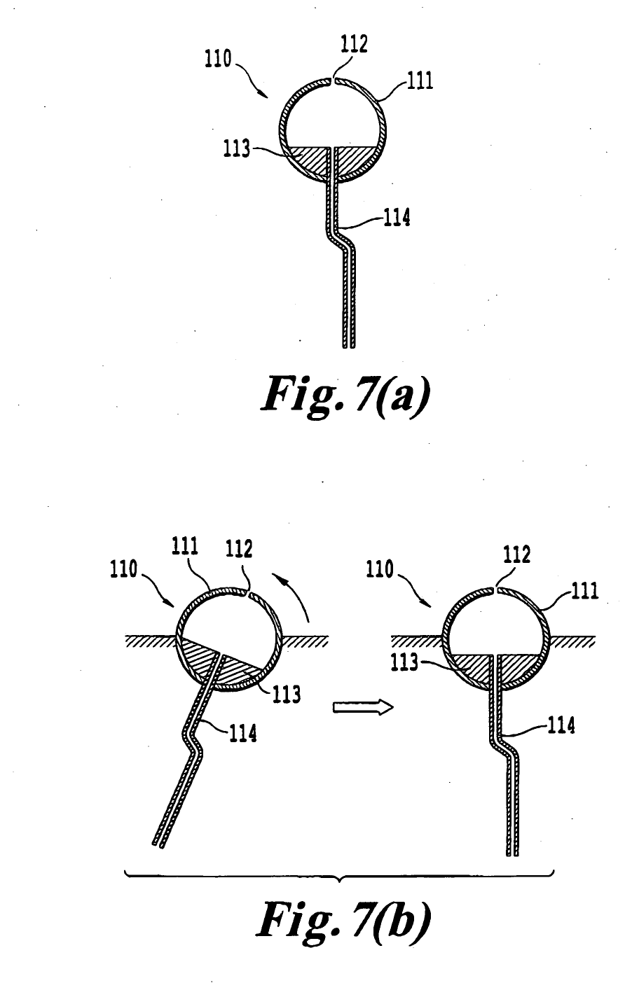

In such case, a float 110 shown in FIG. 7 can be used in place of the gas-liquid separation membrane 105. As shown in FIG. 7(a), a buoyancy bag 111 is provided with a suction port 112, through which gaseous dimethyl ether 13 is supplied to the fuel cell system through the dimethyl-ether supply flow passage 104. The buoyancy bag 111 is provided with a weight 113 so as to enable continuously supplying gaseous dimethyl ether 13 through the suction port 112 also in the case where the fuel tank 101 is turned upside down. The weight 113 is provided so that a center of gravity of the buoyancy bag 111 is positioned away from the suction port 112.

The buoyancy bag 111 is provided with a flexible tube 114 for connection between the buoyancy bag 111 and the dimethyl-ether supply flow passage 104. The flexible tube 114 comprises a hollow pipe to provide for communication between an interior of the buoyancy bag 111 and the dimethyl-ether supply flow passage 104.

With the float 110, a center of gravity of the buoyancy bag 111 is positioned away from the suction port 112 even when the fuel tank 101 for fuel cells is inclined or turned upside down as shown in FIG. 7(b) whereby the positional relationship between a liquid level of dimethyl ether 13 and the float 110 is varied. Therefore, the float 110 moves in a direction in which the positional relationship between the suction port 112 and dimethyl ether 13 is restored. Accordingly, it is possible to continuously supply the gaseous dimethyl ether 13 even in the case where the fuel tank 101 is also turned upside down.

In addition, while it has been described that the float 110 can be used in place of the gas-liquid separation membrane 105, the gas-liquid separation membrane 105 and the float 110 can also be used in combination by providing the gas-liquid separation membrane 105 at the suction port 112.

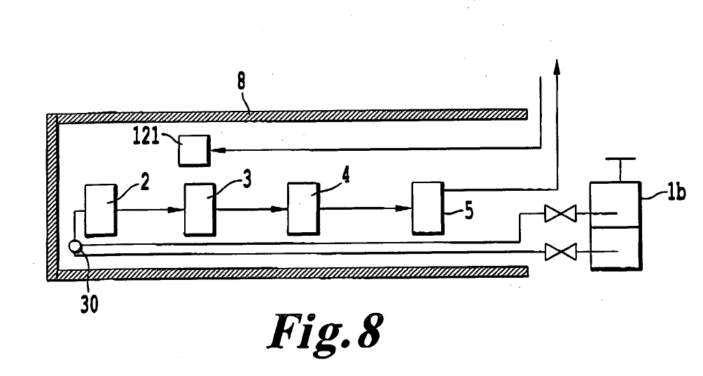

Also, it should not be understood that detailed descriptions and drawings of the respective embodiments limit the invention. Those skilled in the art can think of various alternate embodiments and practical techniques from the disclosure herein. The respective embodiments have been described with respect to an example, in which a fuel tank for fuel cells is used for a fuel cell system. As shown in FIG. 8, a fuel tank for fuel cells having the same construction can also be diverted to use for hydrogen gas generators.

In this case, a heating portion 121 is preferably used in place of the combusting portion 7 provided in the fuel cell system as shown in FIG. 8. The heating portion 121 is provided so that energy, such as electric power, combustion gases, etc., for heating of the vaporization portion 2 can be supplied from outside a hydrogen gas generator. A hydrogen gas generator tank 1b is provided so as to enable supplying a fuel to the hydrogen gas generator.

Like the respective embodiments, such hydrogen gas generator can suppress a phenomenon in which dimethyl ether and water are varied in rate of flow and composition.

Also, the hydrogen gas generator tank 1b is not exposed to a mixed liquid of dimethyl ether and water, which is highly corrosive, and the hydrogen gas generator tank 1b can have an extended service life.

Also, there is no need for any piping or the like, by which saturated vapor pressure of dimethyl ether accommodated in one of spaces is applied to water accommodated in the other of the spaces, so that it is possible to continue operation of the hydrogen gas generator over a further long term.

Also, when the hydrogen gas generator is to be replenished with a further fuel, a user can safely and surely supply a fuel by merely exchanging the hydrogen gas generator tank 1b.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A fuel tank comprising:
a pressure tank including a space configured to accommodate dimethyl ether and water;
a dividing portion dividing the space into spaces so that when one of the spaces is increased in volume, the other of the spaces is decreased in volume and so that the one of the spaces is configured to accommodate dimethyl ether and the other of the spaces is configured to accommodate water;
a first outlet provided on the pressure tank so that the one of the spaces can be opened and dimethyl ether taken out therethrough; and
a second outlet provided on the pressure tank so that the other of the spaces can be opened and water taken out therethrough.

2. The fuel tank according to claim 1, wherein the dividing portion comprises a sheet-shaped member.

3. The fuel tank according to claim 2, wherein the sheet-shaped member comprises a flexible member.

4. The fuel tank according to claim 1, wherein the first outlet is configured in a position in which gaseous dimethyl ether can be taken out through the first outlet.

5. The fuel tank according to claim 1, wherein the second outlet is configured in a position in which liquid water can be taken out through the second outlet.

6. The fuel tank according to claim 1, further comprising a float comprising a suction port, a weight provided in a position in which a center of gravity of the float is away from the suction port, and a flexible tube for communication between an interior of the float and the first outlet.

7. A hydrogen gas generator comprising:
a pressure tank including a space configured to accommodate dimethyl ether and water;
a dividing portion dividing the space into spaces so that when one of the spaces is increased in volume, the other of the spaces is decreased in volume and so that the one of the spaces is configured to accommodate dimethyl ether and the other of the spaces is configured to accommodate water;
a first outlet provided on the pressure tank so that the one of the spaces can be opened and dimethyl ether taken out therethrough;
a second outlet provided on the pressure tank so that the other of the spaces can be opened and water taken out therethrough;
a reforming portion configured to use dimethyl ether and water to obtain a reformed gas containing hydrogen with carbon monoxide (CO); and
a CO removing portion that is configured to remove at least a part of the CO contained in the reformed gas.

8. The hydrogen gas generator according to claim 7, wherein the dividing portion comprises a sheet-shaped member.

9. The hydrogen gas generator according to claim 8, wherein the sheet-shaped member comprises a flexible member.

10. The hydrogen gas generator according to claim 7, wherein the first outlet is configured in a position in which gaseous dimethyl ether can be taken out through the first outlet.

11. The hydrogen gas generator according to claim 7, wherein the second outlet is configured in a position in which liquid water can be taken out through the second outlet.

12. The hydrogen gas generator according to claim 7, further comprising a float comprising a suction port, a weight provided in a position in which a center of gravity of the float is away from the suction port, and a flexible tube for communication between an interior of the float and the first outlet.

13. A fuel cell system comprising:
a pressure tank including a space configured to accommodate dimethyl ether and water;
a dividing portion dividing the space into spaces so that when one of the spaces is increased in volume, the other of the spaces is decreased in volume and so that the one of the spaces is configured to accommodate dimethyl ether and the other of the spaces is configured to accommodate water;
a first outlet provided on the pressure tank so that the one of the spaces can be opened and dimethyl ether taken out therethrough;
a second outlet provided on the pressure tank so that the other of the spaces can be opened and water taken out therethrough;
a reforming portion configured to use dimethyl ether and water to obtain a reformed gas containing hydrogen with carbon monoxide (CO);
a CO removing portion that is configured to remove at least a part of the CO contained in the reformed gas; and
a fuel cell that is configured to use hydrogen contained in the reformed gas and oxygen in the atmosphere to generate electric power.

14. The fuel cell system according to claim 13, wherein the dividing portion comprises a sheet-shaped member.

15. The fuel cell system according to claim 14, wherein the sheet-shaped member comprises a flexible member.

16. The fuel cell system according to claim 13, wherein the first outlet is configured in a position in which gaseous dimethyl ether can be taken out through the first outlet.

17. The fuel cell system according to claim 13, wherein the second outlet is configured in a position in which liquid water can be taken out through the second outlet.

18. The fuel cell system according to claim 13, further comprising a float comprising a suction port, a weight provided in a position in which a center of gravity of the float is away from the suction port, and a flexible tube for communication between an interior of the float and the first outlet.
